(19) United States
(12) Patent Application Publication
(10) Pub. No.: US 2026/0024868 A1
(43) Pub. Date: Jan. 22, 2026

(54) POWER STORAGE DEVICE

(71) Applicant: TOYOTA JIDOSHA KABUSHIKI KAISHA, Aichi-ken (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(21) Appl. No.: 19/212,672

(22) Filed: May 20, 2025

(30) Foreign Application Priority Data
Jul. 17, 2024 (JP) 2024-113834

(51) Int. Cl. H01M 50/325; B60L 50/64; H01M 50/209; H01M 50/249; H01M 50/358

(52) U.S. Cl. CPC H01M 50/325; H01M 50/209; H01M 50/249; H01M 50/358; B60L 50/64; H01M 2220/20

(57) ABSTRACT

The power storage device includes a casing having a frame member, and a power storage unit (power storage module) housed in the casing. The frame member is formed with an exhaust passage that guides the gas discharged from the power storage unit to the outside of the casing. A check valve is provided in the exhaust passage. The check valve is configured to allow the flow of gas out of the casing and to suppress the flow of gas in a direction opposite to the allowed flow of gas.

### CROSS-REFERENCE TO RELATED APPLICATION

This application claims priority to Japanese Patent Application No. 2024-113834 filed on Jul. 17, 2024, incorporated herein by reference in its entirety.

### BACKGROUND

### 1. Technical Field

The present disclosure relates to a power storage device.

### 2. Description of Related Art

Japanese Unexamined Patent Application Publication (Translation of PCT Application) No. 2022-516519 (JP 2022-516519 A) discloses a power storage device that includes a casing and a power storage unit (a plurality of unit cells) that is housed in the casing. Gas that is discharged from the power storage unit is discharged from a discharge port of the casing to outside of the casing. However, a relief valve is provided at the discharge port. The relief valve opens when gas pressure reaches a certain value.

### SUMMARY

The relief valve irreversibly transitions from a state in which the discharge port is closed to a state in which the discharge port is open when discharging gas. In the state in which the discharge port of the casing is open, outside air readily enters into an exhaust passage from the discharge port. Further, when the outside air containing dust enters a high-temperature region around the power storage unit, debris is readily generated.

The present disclosure has been made in order to solve the above problem, and an object thereof is to suppress outside air from entering the high-temperature region around the power storage unit.

A power storage device according to an embodiment of the present disclosure includes a casing that includes a frame member, and a power storage unit that is housed in the casing.

An exhaust passage, for guiding gas that is discharged from the power storage unit to outside of the casing, is fashioned in the frame member.

A check valve is provided in the exhaust passage.

The check valve is configured to allow flow of gas that heads toward outside of the casing, and to suppress flow of gas in a direction opposite to the flow of gas that is allowed.

According to the present disclosure, outside air can be suppressed from entering the high-temperature region around the power storage unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to an embodiment of the present disclosure;

FIG. 2 is a cross-sectional view showing a lower structure of the vehicle shown in FIG. 1;

FIG. 3 is an exploded perspective view of the power storage device shown in FIG. 2;

FIG. 4 is a diagram illustrating an example of a wiring mode of the power storage device illustrated in FIG. 3;

FIG. 5 is a diagram showing an exemplary configuration of the check valve shown in FIG. 4; and

FIG. 6 is a diagram illustrating an example of a slide-type check valve.

### DETAILED DESCRIPTION OF EMBODIMENTS

Embodiments of the present disclosure will be described in detail with reference to the drawings. In the drawings, the same or corresponding parts are denoted by the same reference numerals, and the description thereof will not be repeated. In the drawings used below, among the X-axis, the Y-axis, and the Z-axis orthogonal to each other, the Z-axis indicates the height direction of the power storage device. Hereinafter, “+” is indicated in the direction indicated by the arrows of the X axis, the Y axis, and the Z axis, and “−” is indicated in the opposite direction. −Z direction corresponds to a vertical downward direction (gravitational direction).

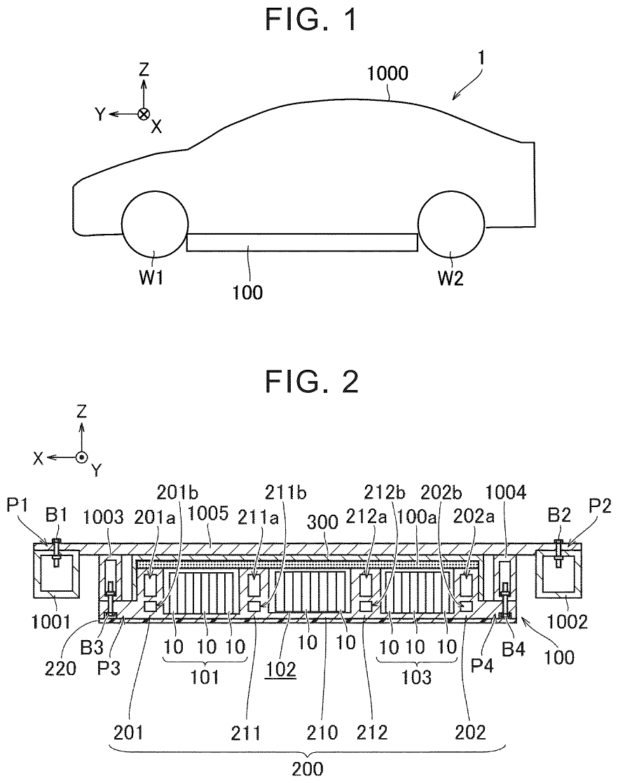

FIG. 1 is a diagram illustrating a schematic configuration of a vehicle 1 according to this embodiment. FIG. 2 is a cross-sectional view illustrating a lower structure of the vehicle 1. The vehicle 1 includes the power storage device 100 illustrated in FIGS. 1 and 2, and is configured to be able to travel using electric power output from the power storage device 100. The vehicle 1 is, for example, a battery electric vehicle (BEV without an internal combustion engine. However, the present disclosure is not limited thereto, and the power storage device 100 may be mounted on a PHEV (plug-in hybrid electric vehicle including an internal combustion engine. Further, the power storage device 100 may be mounted on another electrified vehicle (xEV).

The vehicle 1 further includes a vehicle body 1000, a front wheel W1, and a rear wheel W2. The vehicle body 1000 includes a front portion, a side skeleton, a floor, a roof, and a rear portion. As shown in FIG. 2, the side skeleton of the vehicle body 1000 includes a pair of side sills 1001 and 1002 and a pair of side members 1003 and 1004. The pair of side sills 1001 and 1002 corresponds to both end portions in the width direction (X direction) of the vehicle 1. The side members 1003 and 1004 are located near the inside of the side sills 1001 and 1002, respectively. Each of the side sills 1001 and 1002 and the side members 1003 and 1004 is formed to be long in the front-rear direction (Y direction) of the vehicle 1.

The floor of the vehicle body 1000 includes a cross member 1005 shown in FIG. 2. The cross member 1005 is formed to be long in the width direction (X direction) of the vehicle 1. The +X-side end P1 of the cross member 1005 is secured to the side sill 1001 by fastening member B1 (e.g., bolts and nuts). −X end P2 of the cross member 1005 is secured to the side sill 1002 by fastening member B2 (e.g., bolts and nuts).

The power storage device 100 is disposed, for example, between the front wheel W1 and the rear wheel W2 in the front-rear direction (Y direction) of the vehicle 1. In this embodiment, as shown in FIGS. 1 and 2, the power storage device 100 is located under the floor of the vehicle 1. Specifically, in the width direction (X direction) of the vehicle 1, a central portion (including a power storage unit) of the power storage device 100 is disposed between the side members 1003 and 1004. Therefore, the power storage device 100 is protected by the side members 1003 and 1004. The side members 1003 and 1004 may be connected to the side sills 1001 and 1002 via EA (energy-absorbing) members (not shown), respectively. The upper surface (+Z side surface) of the power storage device 100 may be fixed to the lower surface (−Z side surface) of the floor of the vehicle body 1000. The power storage device 100 may be fixed to the cross member 1005. The upper surface of the power storage device 100 may function as a floor of the vehicle cabin (a floor of the vehicle body 1000).

The power storage device 100 includes a plurality of power storage modules (including the power storage modules 101 to 103 illustrated in FIG. 2) and a casing that houses these power storage modules. Each power storage module includes a plurality of power storage cells 10. In this embodiment, an example is shown in which the number of power storage cells 10 in each power storage module is eight. However, the number of the power storage cells 10 can be changed as appropriate.

The casing of the power storage device 100 includes a LWR (lower) case 200 and a UPR (upper) case 300. LWR case 200 includes a plate-shaped bottom portion 210, a plurality of frame members (including the frame member 201, 202, 211, 212 illustrated in FIG. 2), an end P3 on the +X side, an end P4 on −X side, and an underside cover 220. As will be described in detail later, an exhaust passage (for example, a passage for flue gas) and a wiring passage (for example, a passage in which a cable is disposed) are formed inside each frame member shown in FIG. 2. The underside cover 220 is riveted to, for example, the lower surface (−Z surface) of the bottom portion 210. The underside cover 220 is formed of, for example, fiber reinforced plastic (FRP). The end P3 is secured to the side member 1003 by fastening member B3 (e.g., bolts and nuts). The end P4 is secured to the side member 1004 by fastening member B4 (e.g., bolts and nuts).

The casing of the power storage device 100 further houses the component 100a. The component 100a is located between UPR case 300 and the respective power storage modules. The component 100a includes, for example, a chiller. The cooling plate serves, for example, as a liquid-cooled cooler. The component 100a may further include at least one of a wire (for example, a busbar) that electrically connects the power storage modules, a temperature sensor (for example, a thermistor) that detects a temperature of the at least one power storage module, an insulating sheet, a shock absorber, and a thermally conductive material.

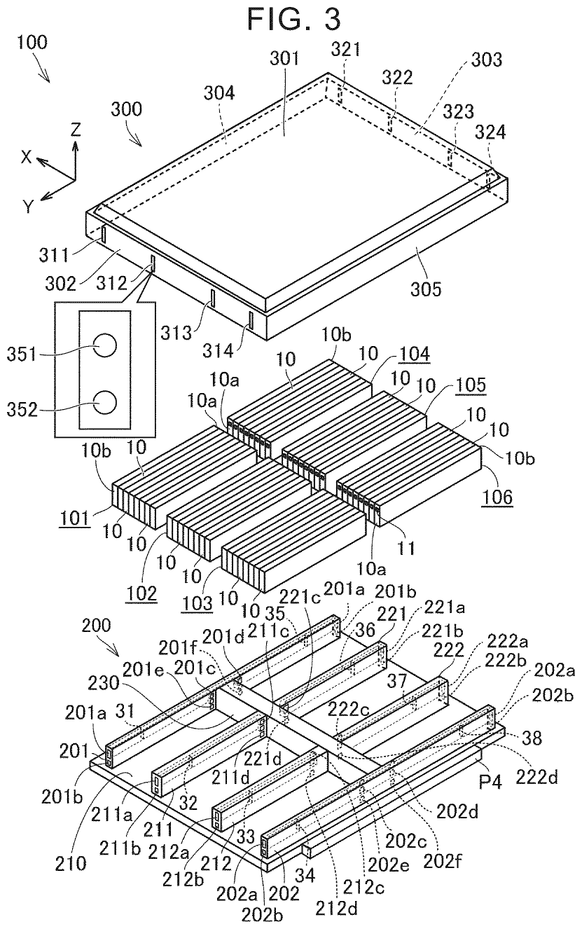

FIG. 3 is an exploded perspective view of the power storage device 100. However, in FIG. 3, the component 100a and the underside cover 220 are omitted.

As shown in FIG. 3, UPR case 300 is formed in a box shape that opens toward −Z. UPR case 300 functions as a cover for LWR case 200. UPR case 300 includes a plate-shaped ceiling portion 301 and wall portions 302 to 305 corresponding to the peripheral wall of the ceiling portion 301. Each of the wall portions 302 to 305 protrudes −Z the ceiling portion 301. Wall portions 302 and 303 face each other in the Y direction. Wall portions 304 and 305 face each other in the X direction. In the wall portion 302, the discharge ports 311 to 314 are formed. In the wall portion 303, the discharge ports 321 to 324 are formed. Each of the discharge ports 311 to 314 and 321 to 324 has a discharge valve 351 and a wiring hole 352. The discharge valve 351 opens when the atmospheric pressure applied to the discharge valve 351 exceeds a predetermined first reference value, and discharges the gas in the casing to the outside of the casing. The discharge valve 351 is configured to irreversibly transition from a state in which the corresponding discharge port is closed to a state in which the corresponding discharge port is open during gas discharge. The discharge valve 351 may be a relief valve. The wiring hole 352 passes a cable (for example, a power line and/or a communication line connected to the power storage unit). In order to improve the airtightness, a sealing member may be provided in the wiring hole 352 through which the 20 cable passes.

LWR case 200 includes a frame member 201, 202, 211, 212, 221, 222, 230 provided on the +Z-side surface of the bottom portion 210. Each frame member protrudes toward +Z side of the bottom portion 210. The frame member 201 is located at the +X side end of the bottom portion 210. The frame member 202 is located at −X end of the bottom portion 210. Each of the frame members 201, 202 is formed to be elongated in the Y-direction from the +Y side end portion to −Y side end portion of the bottom portion 210. The frame member 230 is located substantially in the middle of the bottom portion 210 in the Y direction and between the frame members 201 and 202. The frame member 230 is formed to be elongated in the X-direction from an inner side (−X side) surface of the frame member 201 to an inner side (+X side) surface of the frame member 202.

The frame members 211 and 212 are provided so as to divide the +Y side region partitioned by the frame member 201, 202, 230 into approximately three equal parts. Each of the frame members 211, 212 is formed to be elongated in the Y direction from an end portion of the bottom portion 210 on the +Y side to the frame member 230. The frame members 221 and 222 are provided so as to divide −Y area partitioned by the frame member 201, 202, 230 into approximately three equal parts. Each of the frame members 221, 222 is elongated in the Y-direction from −Y end of the bottom portion 210 to the frame member 230. The frame members 211 and 221 face each other in the Y direction with the frame member 230 interposed therebetween. The frame members 212 and 222 face each other in the Y direction with the frame member 230 interposed therebetween.

The power storage device 100 includes power storage modules 101 to 106. Each of the power storage modules 101 to 106 functions as a power storage unit of the power storage device 100. Each of the power storage modules 101 to 106 has a structure in which a plurality of power storage cells 10 (for example, eight power storage cells 10) are stacked in the X direction. An electrode body is housed in a case of the power storage cell 10. The electrode body is, for example, a wound body in which a positive electrode sheet and a negative electrode sheet are wound with a separator interposed therebetween. For example, one or more windings functioning as electrode bodies may be housed in a metallic square case covered by a laminate casing. However, the electrode body may be a laminate in which a positive electrode sheet and a negative electrode sheet are laminated with a separator interposed therebetween. Each of the positive electrode sheet and the negative electrode sheet includes an electrode foil and an active material layer. The power storage cell 10 is, for example, a secondary battery such as a lithium ion battery, a nickel metal hydride battery, or a sodium ion battery. Examples of the lithium-ion battery include a LFP cell in which lithium iron phosphate is employed as a positive electrode active material, or a ternary cell in which NMC (nickel-manganese-cobalt) is employed as a positive electrode active material. The type of the secondary battery may be a liquid secondary battery or a solid secondary battery.

The power storage modules 101 to 106 are arranged in six regions partitioned by frame members. Specifically, the power storage module 101 is located in the first region partitioned by the frame member 201, 211, 230. The power storage module 102 is located in the second region partitioned by the frame member 211, 212, 230. The power storage module 103 is located in the third region partitioned by the frame member 212, 202, 230. The power storage module 104 is located in the fourth region partitioned by the frame member 201, 221, 230. The power storage module 105 is located in the fifth region partitioned by the frame member 221, 222, 230. The power storage module 106 is located in the sixth region partitioned by the frame member 222, 202, 230.

The power storage cell 10 has a rectangular parallelepiped shape whose longitudinal direction is the Y direction. The ratio of the length (the dimension in the Y direction) to the width (the dimension in the X direction) of the power storage cell 10 may be 4 or more and 25 or less. The power storage cell 10 may have a width and a length of about 50 mm and about 1000 mm, respectively. In this embodiment, the height (dimension in the Z direction) of the power storage cell 10 is equal to or less than the height of each frame member. The height of the power storage cell 10 may be about 100 mm.

The power storage cell 10 has a first end face 10a and a second end face 10b in the longitudinal direction (Y direction). The first end face 10a has an exhaust valve 11. The exhaust valve 11 opens when the internal pressure (pressure in the case) of the power storage cell 10 exceeds a predetermined second reference value, and discharges the gas in the case to the outside of the case. The second reference value may be higher than the first reference value. The exhaust valve 11 may be a relief valve. In each of the power storage modules 101 to 103, the power storage cells are arranged such that the second end face 10b faces the +Y side and the first end face 10a faces −Y side. In each of the power storage modules 104 to 106, the power storage cells are arranged such that the first end face 10a faces the +Y side and the second end face 10b faces −Y side.

Inside the frame member 201, as shown in FIGS. 2 and 3, an exhaust passage 201a and a wiring path 201b that penetrate the frame member 201 in the Y-direction are formed. The wiring path 201b is located −Z of the exhaust passage 201a.

On a surface of the frame member 201 facing the power storage module 101, one or more openings 201c (for example, two openings 201c arranged in the Z-direction) connected to the exhaust passage 201a and one or more openings 201e connected to the wiring path 201b from the same surface are formed. The opening 201c and 201e are located near the +Y-side of the frame member 230. A check valve 31 is further provided on the +Y-side of the exhaust passage 201a with respect to the opening 201c.

On a surface of the frame member 201 facing the power storage module 104, one or more openings 201d (for example, two openings 201d arranged in the Z-direction) connected to the exhaust passage 201a and one or more openings 201f connected to the wiring path 201b from the same surface are formed. The opening 201d and 201f are located near −Y of the frame member 230. A check valve 35 is further provided −Y of the opening 201d in the exhaust passage 201a.

Inside the frame member 202, an exhaust passage 202a and a wiring path 202b that penetrate the frame member 202 in the Y-direction are formed. The wiring path 202b is located −Z of the exhaust passage 202a.

On a surface of the frame member 202 facing the power storage module 103, one or more openings 202c (for example, two openings 202c arranged in the Z-direction) connected to the exhaust passage 202a and one or more openings 202e connected to the wiring path 202b from the same surface are formed. The opening 202c and 202e are located near the +Y-side of the frame member 230. A check valve 34 is further provided on the +Y-side of the exhaust passage 202a with respect to the opening 202c.

On a surface of the frame member 202 facing the power storage module 106, one or more openings 202d (for example, two openings 202d arranged in the Z-direction) connected to the exhaust passage 202a and one or more openings 202f connected to the wiring path 202b from the same surface are formed. The opening 202d and 202f are located near −Y of the frame member 230. A check valve 38 is further provided −Y of the opening 202d in the exhaust passage 202a.

Inside the frame members 211 and 212, an exhaust passage 211a, 212a and a wiring path 211b, 212b that extend in the Y-direction from the +Y-side end surface to −Y side end portion of the frame members 211 and 212, respectively, are formed. Each of the wiring paths 211b, 212b is located −Z of the exhaust passage 211a, 212a.

At −Y end of the frame member 211, one or more openings 211c (e.g., two openings 211c arranged in the Z-direction) connected to the exhaust passage 211a from the surface of the frame member 211 facing the power storage module 102 and one or more openings 211d connected to the wiring path 211b from the same surface are further formed. A check valve 32 is further provided on the +Y-side of the exhaust passage 211a with respect to the opening 211c. At −Y end of the frame member 212, one or more openings 212c (e.g., two openings 212c arranged in the Z-direction) connected to the exhaust passage 212a from the surface of the frame member 212 facing the power storage module 102 and one or more openings 212d connected to the wiring path 212b from the same surface are further formed. A check valve 33 is further provided on the +Y-side of the exhaust passage 212a with respect to the opening 212c.

Inside the frame members 221 and 222, an exhaust passage 221a, 222a and a wiring path 221b, 222b extending in the Y-direction from −Y end surfaces of the frame members 221 and 222 to +Y side end portions are formed. Each of the wiring paths 221b, 222b is located −Z of the exhaust passage 221a, 222a.

At the +Y-side end of the frame member 221, one or more openings 221c (e.g., two openings 221c arranged in the Z-direction) connected to the exhaust passage 221a from the surface of the frame member 221 facing the power storage module 105 and one or more openings 221d connected to the wiring path 221b from the same surface are further formed. A check valve 36 is further provided −Y of the opening 221c of the exhaust passage 221a. At the +Y-side end of the frame member 222, one or more openings 222c (e.g., two openings 222c arranged in the Z-direction) connected to the exhaust passage 222a from the surface of the frame member 222 facing the power storage module 105 and one or more openings 222d connected to the wiring path 222b from the same surface are further formed. A check valve 37 is further provided −Y of the opening 222c in the exhaust passage 222a.

The exhaust passage 201a is formed to guide the gases discharged from the power storage modules 101 and 104 to the discharge ports 311 and 321. The exhaust passage 202a is formed to guide the gases discharged from the power storage modules 103 and 106 to the discharge ports 314 and 324. The exhaust passage 211a, 212a is formed so as to guide the gases discharged from the power storage module 102 to the discharge ports 312 and 313, respectively. The exhaust passage 221a, 222a is formed so as to guide the gases discharged from the power storage module 105 to the discharge ports 322 and 323, respectively. However, before the gas discharge, each exhaust passage is closed by the discharge valve 351 of the corresponding discharge port.

As described above, one or more passages are formed in each of the frame members 201, 202, 211, 212, 221, 222. On the other hand, no passage is formed inside the frame member 230 that separates the +Y side region and −Y side region of LWR case 200. The frame member 230 has a solid structure. This improves the rigidity of the central portion of the power storage device 100. Each end face of the frame member 211, 212, 221, 222 may be joined (e.g., welded) to the frame member 230. In the power storage device 100, a plurality of exhaust passages are assigned to each of the power storage modules 102, 105 located in the center. In this way, the exhaust gas is promoted in the central portion of the power storage device 100, and the temperature rise is suppressed.

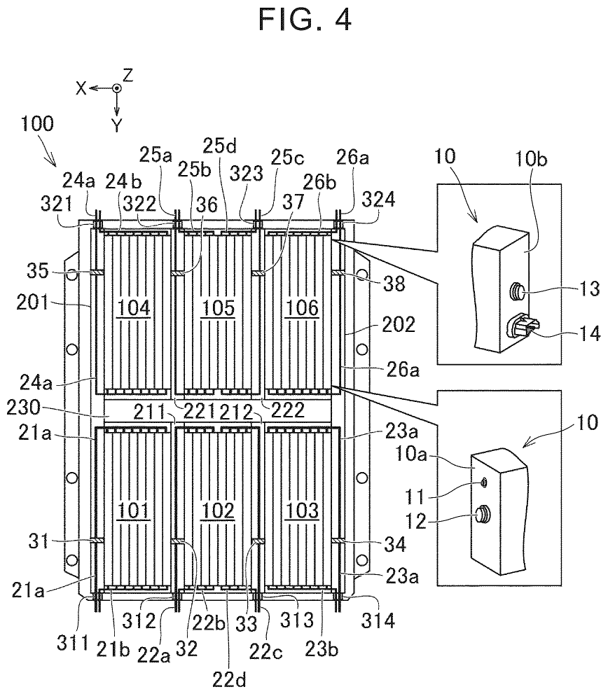

FIG. 4 is a diagram illustrating an example of a wiring mode of the power storage device 100. Referring to FIG. 4, an external terminal 12 is provided on the first end face 10a of the power storage cell 10 in addition to the above-described exhaust valve 11. An external terminal 13 and a connector 14 are provided on the second end face 10b of the power storage cell 10. Each of the external terminals 12 and 13 has an electrode tab that functions as a negative electrode or a positive electrode of the power storage cell 10. An insulating sealing structure made of ceramic may be formed around the electrode tab. In this embodiment, the external terminals 12 and 13 function as a positive terminal and a negative terminal, respectively. However, the present disclosure is not limited thereto, and the external terminal 12 may be the negative electrode terminal and the external terminal 13 may be the positive electrode terminal, with the polarity reversed. The connector 14 includes an output terminal that outputs a detection signal indicating a state in the case (for example, an internal temperature of the power storage cell 10) detected by one or more sensors in the case to the outside of the case. For example, a temperature sensor may be provided for each power storage cell in the case. The connector 14 may further include an input terminal for inputting a control signal from the outside of the case to one or more devices in the case.

The first end face 10a (−Y of each of the power storage cells included in the power storage modules 101 and 103 is connected to the first line 21a, 23a. Each of the first lines 21a, 23a extends from the power storage modules 101 and 103 to the outside of the casing of the power storage device 100 through the opening 201e, 202e shown in FIG. 3 and further through the wiring path 201b, 202b and the wiring holes 352 of the discharge ports 311 and 314. The second end faces 10b (+Y-side end faces) of the power storage cells included in the power storage modules 101 and 103 are respectively connected to the second lines 21b, 23b. The second lines 21b, 23b extend from the power storage modules 101 and 103 to the outside of the casing of the power storage device 100 through the interconnection holes 352 of the discharge ports 311 and 314, respectively.

Among the plurality of power storage cells 10 included in the power storage module 102, the first end face 10a and the second end face 10b of some of the power storage cells 10 are connected to the first line 22a and the second line 22b, respectively, and the first end face 10a and the second end face 10b of the remaining power storage cells 10 are connected to the first line 22c and the second line 22d, respectively. The first line 22a, 22c connected to the first end face 10a (−Y) extends from the power storage module 102 to the outside of the casing of the power storage device 100 through the opening 211d, 212d shown in FIG. 3 and further through the wiring path 211b, 212b and the wiring holes 352 of the discharge ports 312 and 313. The second line 22b, 22d connected to the second end face 10b (+Y-side end face) extends from the power storage module 102 to the outside of the casing of the power storage device 100 through the wiring holes 352 of the discharge ports 312 and 313, respectively.

The first end faces 10a (+Y-side end faces) of the power storage cells included in the power storage modules 104 and 106 are respectively connected to the first lines 24a, 26a. Each of the first lines 24a, 26a extends from the power storage modules 104 and 106 to the outside of the casing of the power storage device 100 through the opening 201f, 202f shown in FIG. 3 and further through the wiring path 201b, 202b and the wiring holes 352 of the discharge ports 321 and 324. The second end face 10b (−Y of each of the power storage cells included in the power storage modules 104 and 106 is connected to the second line 24b, 26b. The second lines 24b, 26b extend from the power storage modules 104 and 106 to the outside of the casing of the power storage device 100 through the interconnection holes 352 of the discharge ports 321 and 324, respectively.

Among the plurality of power storage cells 10 included in the power storage module 105, the first end face 10a and the second end face 10b of some of the power storage cells 10 are connected to the first line 25a and the second line 25b, respectively, and the first end face 10a and the second end face 10b of the remaining power storage cells 10 are connected to the first line 25c and the second line 25d, respectively. The first line 25a, 25c connected to the first end face 10a (+Y-side end face) extends from the power storage module 105 to the outside of the casing of the power storage device 100 through the opening 221d, 222d shown in FIG. 3, and further through the wiring path 221b, 222b and the wiring holes 352 of the discharge ports 322 and 323. The second line 25b, 25d connected to the second end face 10b (−Y) extends from the power storage module 105 to the outside of the casing of the power storage device 100 through the wiring holes 352 of the discharge ports 322 and 323, respectively.

Each of the first lines 21a to 26a, 22c, 25c includes a first power line (for example, a positive power line) connected to the external terminals 12 of the respective power storage cells. Each of the second lines 21b to 26b, 22d, 25d includes a second power line (for example, a negative power line) connected to the external terminal 13 of each power storage cell, and a communication line connected to the connector 14 of each power storage cell.

In this embodiment, at one end (the frame member 230 side) of each power storage module, electrodes (for example, positive electrodes) of the same polarity of adjacent power storage cells are electrically connected to each other. Also, at the other end of each power storage module (from the discharge port 311 to the 314 side or from the discharge port 321 to the 324 side), electrodes (for example, negative electrodes) of the same polarity of the adjacent power storage cells are electrically connected to each other. As described above, the plurality of power storage cells 10 are connected in parallel in each of the power storage modules. However, the present disclosure is not limited thereto, and a plurality of power storage cells in each power storage module may be connected in series. For example, a first power storage cell in which the external terminal 12 is a positive electrode and the external terminal 13 is a negative electrode, and a second power storage cell in which the external terminal 12 is a negative electrode and the external terminal 13 is a positive electrode may be alternately arranged. Then, the positive electrode and the negative electrode of the adjacent power storage cells may be electrically connected to each other, so that the power storage cells may be connected in series. Outside the casing of the power storage device 100, the first power line and the second power line of each power storage module are connected so that, for example, the power storage modules 101 to 106 are electrically connected in series. However, the present disclosure is not limited thereto, and the power storage modules 101 to 106 may be electrically connected in parallel.

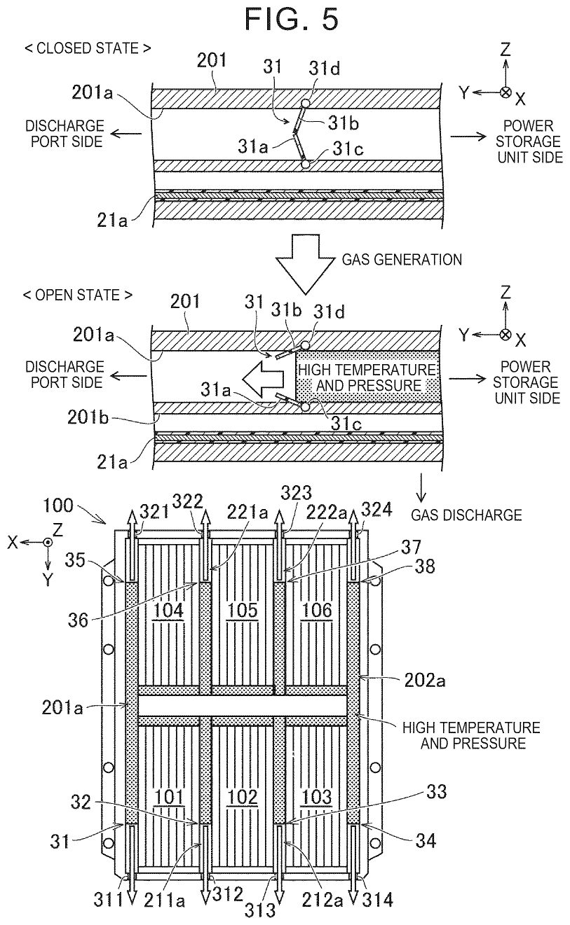

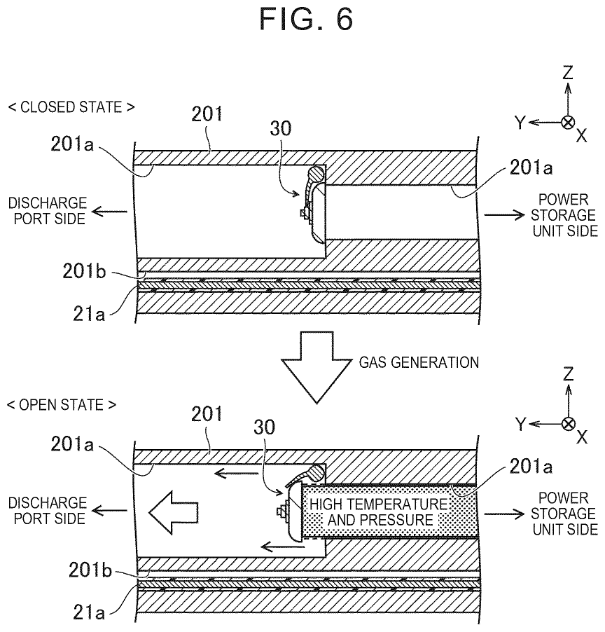

In this embodiment, check valves 31 and 35 are provided in the exhaust passage 201a. Check valves 34 and 38 are provided in the exhaust passage 202a. Check valves 32, 33, 36, and 37 are provided in the exhaust passage 211a, 212a, 221a, 222a, respectively. Each check valve is configured to allow the flow of gas out of the casing of the power storage device 100 and suppress the flow of gas in a direction opposite to the allowed flow of gas. In this embodiment, each check valve blocks the flow of gas entering the casing from the outside of the casing of the power storage device 100. Specifically, each check valve has the structure shown in FIG. 5 described below.

FIG. 5 is a diagram illustrating an example of a structure of a check valve. Referring to FIG. 5, the check valve 31 includes a plate member 31a (first plate), a plate member 31b (second plate), a support portion 31c that rotatably supports the plate member 31a, and a support portion 31d that rotatably supports the plate member 31b. Each of the plate member 31a and 31b is, for example, a resin-made plate. The plate member 31a and the plate member 31b may be configured to be plane-symmetric with respect to XY plane. When the check valve 31 is closed, the front ends of the plate member 31a and 31b are contacted with each other so as to close the exhaust passage 201a. The check valve 31 does not allow gases to flow −Y.

When the gas is discharged from the exhaust valve 11 of the one or more power storage cells 10 and the pressure and temperature of the space near the frame member 230 closed by the check valves 31 to 38 increase, the gas flows in the Y direction. The plate members 31a and 31b of the check valve 31 are pushed by the gases and rotate about the X-axis so as to be spaced apart from each other. In this way, the check valve 31 is opened. As a result, the exhaust passage 201a is opened. When the check valve 31 is opened, the high-temperature and high-pressure gas breaks the discharge valve 351 in addition to the discharge valve 351 of the discharge port 311 at a pressure exceeding the first reference value. Thus, the discharge port 311 is opened. The opened discharge valve 351 does not return to the valve-closed state even after the high-temperature and high-pressure gas is discharged to the outside of the casing. On the other hand, when the pressure of the gas decreases, the check valve 31 returns to the closed state.

When the discharge valve 351 opens the discharge port 311, outside air containing dust easily enters the exhaust passage 201a. However, the outside air is shut off by the check valve 31. Therefore, it is suppressed that the outside air enters a high-temperature region (for example, a region −Y of the check valve 31) around the power storage unit.

Although only the structure around the check valve 31 is shown in FIG. 5, other check valves (check valves 32 to 38) have the same structure as the check valve 31. The other check valves are also opened by the pressure of the gas discharged from the power storage cell 10. Each of the check valves 31 to 38 is disposed at a position closer to the discharge port of the casing (from the discharge ports 311 to 314, 321 to 324) than the gas discharge port of the power storage unit (the exhaust valve 11) on the path of the gas flowing through the corresponding exhaust passage. This makes it easier to prevent the outside air from entering the high-temperature region. The gas discharged from the power storage cell 10 passes through the corresponding exhaust passage and is discharged to the outside from the corresponding discharge port. The discharged gas may be guided to a predetermined location by a duct provided outside the casing.

In the embodiment illustrated in FIG. 5, the plate member 31a and 31b are arranged in the Z-direction. However, the present disclosure is not limited thereto, and the plate members 31a and 31b may be arranged in the X direction or the Y direction. A proximal end portion of each of the plate member 31a and 31b may be supported by the side wall. Each of the plate member 31a and 31b may be a metallic plate. A seal member (for example, a rubber component) may be provided at a tip portion of each plate member. A biasing member (e.g., a torsion spring) may be provided that biases each plate member in a direction in which the valve closes.

As described above, the power storage device 100 according to this embodiment includes a casing (LWR case 200 and UPR case 300) and a power storage unit (the power storage modules 101 to 106) housed in the casing. The casing includes frame members 201, 202, 211, 212, 221, and 222 each having an exhaust passage 201a, 202a, 211a, 212a, 221a, 222a for guiding the gases discharged from the power storage unit to the outside of the casing. A check valve (check valves 31 to 38) is provided in each of the exhaust passage 201a, 202a, 211a, 212a, 221a, 222a. Each of the check valves 31-38 is configured to allow the flow of gas out of the casing and to suppress the flow of gas in a direction opposite to the allowed flow of gas. In such a power storage device 100, the flow of the gas entering the casing from the outside of the casing is blocked by the check valves 31 to 38. Therefore, it is possible to suppress the outside air from entering the high-temperature region around the power storage unit. The check valves 31 to 38 operate mechanically in response to the pressure of the gas, so that the flow of the gas can be controlled without electronic control.

Each of the check valves 31 to 38 is opened and closed by a rotation operation of a plurality of plates. Such a check valve is unlikely to be hindered by debris. However, the present disclosure is not limited to the rotary check valve, and a slide check valve or a duckbill check valve can also be employed. FIG. 6 is a diagram illustrating an example of a slide-type check valve.

For example, instead of at least one of the check valves 31 to 38, the sliding check valve 30 shown in FIG. 6 may be employed. In the example shown in FIG. 6, a check valve 30 is employed instead of the check valve 31. The check valve 30 is disposed in a stepped portion formed in the exhaust passage 201a, and does not allow the gases to flow-Y. On the other hand, when the flow of the gas toward the +Y side is generated, the valve body of the check valve 30 is pushed by the gas and slides toward the +Y side. In this way, the check valve 30 is opened.

The discharge valves 351 of the respective discharge ports may be changed to vent holes (for example, holes passing through UPR case 300). In such a power storage device, the outside air entering the casing from the vent holes of the respective discharge ports is blocked by the check valves 31 to 38.

The embodiment disclosed this time should be considered to be illustrative in all respects and not restrictive. It is intended that the scope of the disclosure be defined by the appended claims rather than the description of the embodiments described above, and that all changes within the meaning and range of equivalency of the claims be embraced therein.

What is claimed is:

1. A power storage device, comprising:
a casing that includes a frame member; and a power storage unit that is housed in the casing, wherein
an exhaust passage, for guiding gas that is discharged from the power storage unit to outside of the casing, is fashioned in the frame member,
a check valve is provided in the exhaust passage, and
the check valve is configured to allow flow of gas that heads toward outside of the casing, and to suppress flow of gas in a direction opposite to the flow of gas that is allowed.

2. The power storage device according to claim 1, wherein
the check valve includes a first plate and a second plate,
in a state in which the check valve is closed, the first plate and the second plate are in contact so as to close the exhaust passage, and
the check valve is configured to open the exhaust passage by being pushed by the gas that is discharged from the power storage unit and the first plate and the second plate being separated.

3. The power storage device according to claim 1, wherein
a discharge port is fashioned in the casing,
the exhaust passage is fashioned so as to guide the gas that is discharged from the power storage unit to the discharge port, and
the check valve is disposed at a position on a path of the gas flowing through the exhaust passage that is closer to the discharge port than a gas discharge port of the power storage unit.

4. The power storage device according to claim 3, wherein
the discharge port is provided with a discharge valve, and
the discharge valve is configured to irreversibly transition from a state in which the discharge port is closed to a state in which the discharge port is open during gas discharge.
